(19) United States
(12) Patent Application Publication
(10) Pub. No.: US 2012/0109609 A1
(43) Pub. Date: May 3, 2012

(54) Online media and presentation interaction method

(76) Inventors: Michael Weber, New Orleans, LA (US); Christopher Schmidt, Fairfax, CA (US); Michael Leifer, Fairfax, CA (US); Michael Buehler, Fairfax, CA (US)

(21) Appl. No.: 13/287,984

(22) Filed: Nov. 2, 2011

Related U.S. Application Data
(60) Provisional application No. 61/409,316, filed on Nov. 2, 2010.

(51) Int. Cl. G06G 7/48

(52) U.S. Cl. 703/6

(57) ABSTRACT

A method for interacting with media content and associated data or interactions have been described. According to one embodiment, a computer-implemented method includes the ability to display, manipulate and interact with multimedia content, view associated data, and perform additional interactive functions associated with the displayed content within a limited, virtual, 3-dimensional space presented via a web browser or other computing device.

### CONTINUITY DATA

This is a non-provisional application of provisional patent application No. 61/409,316 filed on Nov. 2, 2010, and priority is claimed thereto.

### FIELD OF THE PRESENT INVENTION

The present invention relates generally to online content presentation and interaction. In particular, the present method and system is directed to displaying media objects, associated data and interactions within a web browser or other software on an interactive media display device.

### BACKGROUND OF THE PRESENT INVENTION

Organizations and individuals have constantly sought methods for the display of and interaction with a large number of multimedia assets from a single or multiple sources. Traditional solutions have included manual aggregation of these assets and custom-developed presentations in HTML, Flash or other environments, and have typically been restricted to a static set of assets as defined by the content author.

The problem with existing methods for display and interaction with multimedia is that users tend to be accustomed to physical interactions, and the existing methods simply do not provide a compelling version of physically interacting with the multimedia. For example, seeing a list of pictures taken with a digital camera in a conventional WINDOWS™ file window is a conventional means of displaying the pictures located in a particular folder on a computer. However, in the real physical world, pictures would not be listed in a window with times and dates and file types though.

Thus, there exists a need for providing electronic access to multimedia while maintaining a semblance of the physical world, in order to make viewing and interaction with multimedia simpler, easier, and more intuitive.

### SUMMARY OF THE PRESENT INVENTION

The present invention is a system and method for the presentation of and interaction with multimedia content and associated data, such as, but not limited to authorship and copyright information, content description, location information, and data collection.

The present invention provides users the ability to view, manipulate and interact with multimedia content, view associated data and perform additional interactive functions associated with the displayed content within a limited virtual 3-dimensional space presented via a web browser or other interactive display device.

In other words, the present invention is a system and method, in combination with a computer or server, for presenting, organizing and manipulating multimedia on a screen as if the multimedia were actual pictures on a desktop. The multimedia can be piled, one on top of another, just as pictures are stacked on top of one another in the physical world. Notations and other information are available for each digital picture, for example, by simple flipping the digital picture over on the digital space on the screen—much like in the physical world. Multimedia can be tossed next to a pile, spread out on the screen, and haphazardly or dutifully organized either programmatically, or by a user, on the screen like pictures would be organized on a table top in the physical world.

According to one embodiment, a computer-implemented method, the system is a method of presentation of and interaction with multimedia content and associated data or functions.

The system provides a near-unlimited space in the form of a virtual display layer in which media assets are loaded and displayed. This amounts to a seemingly infinitely scrollable virtual desktop that exists underneath the media objects. It is envisioned that this apparently infinitely scrollable desktop may have the appearance of being a corkboard, table, whiteboard, or any other background image.

The system provides a method of manipulating the horizontal, vertical and virtual depth positions of displayed media assets. Thus, the media objects may be resized when located on the virtual desktop, also referred to as a wall.

The system provides a method of presenting information and interactivity on the reverse plane of two-dimensional objects displayed as virtual 3-dimensional objects within a 2-dimensional display space. The system provides a method of media asset aggregation and display from multiple first or third party data sources, abstracting the user from the source of the media and other data, with optional caching for performance improvement.

The system provides the ability for unique selections of media assets to be displayed based upon user interaction.

The above and other preferred features, including various novel details of the implementation and combination of elements, will now be more particularly described with reference to the accompanying drawings and pointed out in the claims. It will be understood that the particular methods and circuits described herein are shown using illustration only and not as limitations. As will be understood by those skilled in the art, the principles and features described herein may be employed in various and numerous embodiments without departing from the scope of the invention.

### BRIEF DESCRIPTION OF THE DRAWINGS

FIG. 1 illustrates an exemplary presentation and interaction model, according to one embodiment of the present invention;

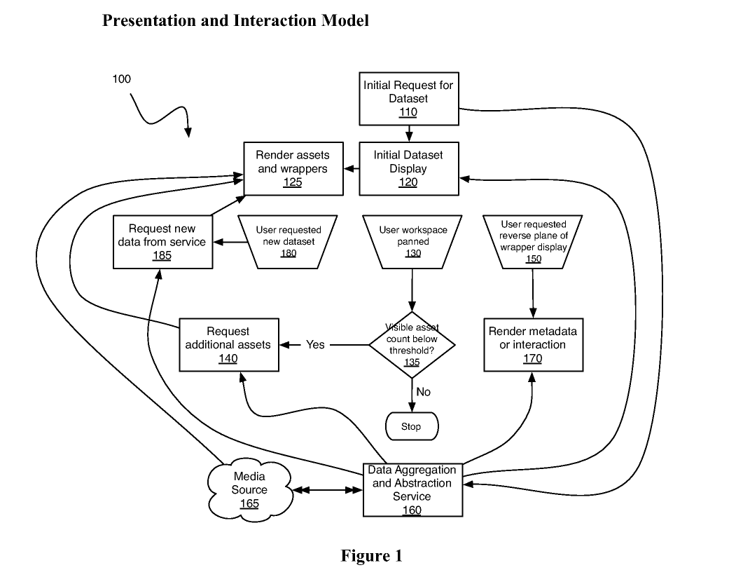

FIG. 2 illustrates an exemplary content aggregation, caching and abstraction model, according to one embodiment of the present invention;

FIG. 3 illustrates an exemplary personal computer, according to one embodiment of the present invention;

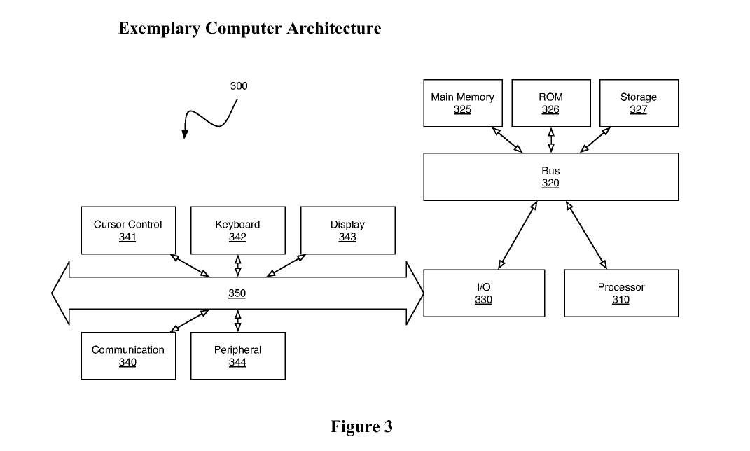

FIG. 4 displays an embodiment of the toolbar incorporated into the presentation and interaction model of the present invention.

### DETAILED DESCRIPTION OF THE PREFERRED EMBODIMENT

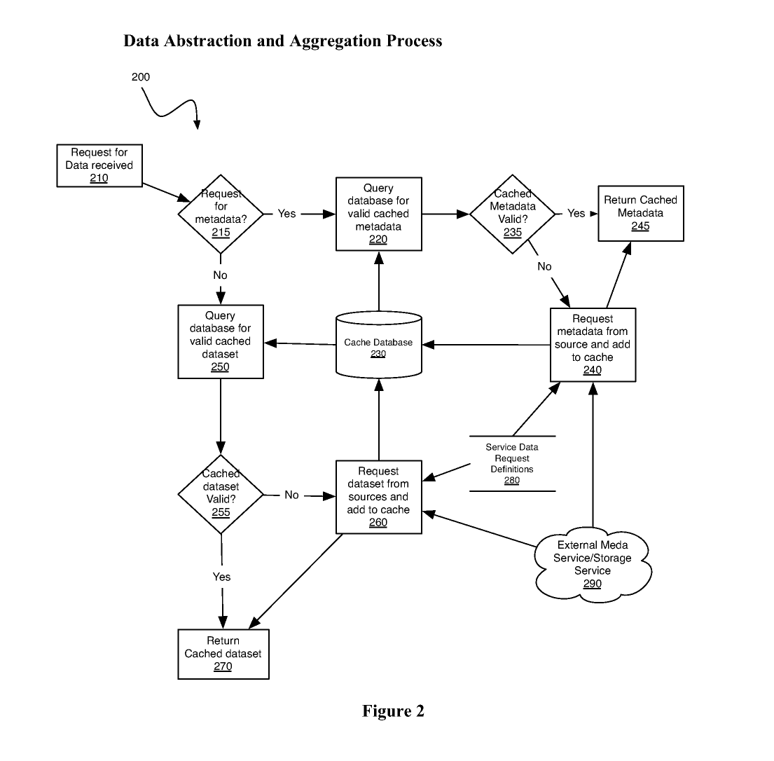

The presentation and interaction system (100), upon load, will perform an initial request for a dataset (110), declared by the media presenter or via application defaults. The initial request for a dataset (110) is displayed to the user as an initial dataset display (120) as a quasi-three-dimensional representation of 2-dimensional objects on a pannable (movable) workspace with near unlimited dimensions via data provided by the data aggregation and abstraction service (160) and media from the media source (165) via a repeated instantiation of an asset rendering wrapper shown as “render assets and wrappers” (125). The workspace provides ability to reposition elements displayed and provides repositioning of the element's stacking (Z) order to allow the element to be visible and not obscured by other displayed elements. Data provided by the data aggregation and abstraction service (160) is formatted using an application specific data structure, independent of the data provided by the media source (165). In the event the user requests an entire new data set via a search function, links provided or other means, shown as “user requested new dataset” (180), the workspace is regenerated and/or repopulated via the same process as above excepting that the request for data is provided based upon the user specified parameters, shown as “request new data from service” (185). In the event that the user pans (drags, or otherwise moves with a peripheral device such as cursor control (341) or keyboard (342)) the workspace containing the media assets, shown as “user workspace panned” (130), application logic determines based upon the count of assets visible within the on-screen portion of the workspace, shown as “visible asset count below threshold?” (135), if additional media should be requested, shown as “request additional assets” (140) and displayed, shown as “render assets and wrappers” (125). In the event the user requests interaction with the reverse plane of the displayed element, shown as “user requested reverse plane of wrapper display” (150) a request to the data abstraction and aggregation service (160) for the data and/or interaction to be displayed is performed, and the data or interaction is rendered by the application, shown as “render metadata or interaction” (170) in FIG. 2. All of the above processes excepting the initial display, shown as “initial request for dataset” (110) may be repeated as needed, based upon user interactions.

The data aggregation service (200) provides data to fulfill requests made by the presentation and interaction system (100), and may optionally perform data caching to increase performance. When a request for data is received, shown as “request for data received” (210), a determination based upon the request is made as to the type of data requested, shown as “request for metadata?” (215). If the request is for metadata or interaction data to be displayed in the reverse plane of the media wrapper, the cache database (230) is queried, shown as “query database for valid cached metadata” (220) and the metadata is determined valid, shown as “cached metadata valid?” (235) by a set of predetermined criteria before being sent back to the display and interaction client, shown as “return cached metadata” (245). In the event the cached metadata is determined invalid or unavailable, a request for new metadata is made, shown as “request metadata from source and add to cache” (240) and stored in the cache, shown as “cache database” (230) before being returned to the display and interaction client, shown as “return cached metadata” (245). If the request is for a dataset, the cache database (230) is queried, shown as “query database for valid cached dataset” (250) and determined valid, shown as “cached dataset valid” (255) by a set of predetermined criteria before being sent back to the display and interaction client, shown as “return cached dataset” (270). In the event the cached dataset is determined to be invalid or unavailable, a request for new data is made, shown as “request dataset from sources and add to cache” (260) and added to the cache, shown as “cache database” (230) before being returned to the display and interaction client, shown as “return cached dataset” (270). The entire system of caching is optional and may be omitted as required or preferred for implementation.

One embodiment of the architecture (300) comprises a system bus (320) for communicating information, and a processor (310) coupled to the bus (320) for processing information. The architecture (300) further comprises a random access memory (RAM) or other dynamic storage device (325) (referred to herein as main memory), coupled to the bus (320) for storing information and instructions to be executed by the processor (310). Main memory (325) also may be used for storing temporary variables or other intermediate information during execution of instructions by the processor (310). The architecture (300) also may include a read only memory (ROM) (326) and/or other static storage device coupled to the bus (320) for storing static information and instructions used by the processor (310).

A data storage device, shown as “storage” (327) such as a flash memory, a magnetic disk or optical disc and its corresponding drive may also be coupled to the computer system architecture (300) for storing information and instructions. The architecture (300) can also be coupled to I/O bus (350) via an I/O interface, shown as “I/O” (330). A plurality of I/O devices may be coupled to the I/O bus (350), including a display device, shown as “display” (343), an input device (e.g., an alphanumeric input device, shown as “keyboard” (342) and/or a cursor control device, shown as “cursor control” (341)).

The communication device, shown as “communication” (340), allows for access to other computers (servers or clients) via a network. The communication device, shown as “communication” (340), may comprise a modem, a network interface card, a wireless network interface or other well-known interface device, such as those used for coupling to Ethernet, token ring, or other types of networks. The present system's web services are a combination of client-side and server-side components, and may include schemas, hardware servers, software servers, and other components and services. The software foundation may be a combination of Linux, Apache, MySQL and PHP, Windows, IIS, .NET and SQL Server or other web servers, development environments and DBMS systems appropriate to the deployment system platform.

The present system can be instantiated to support media presentation and interaction for web browsers, cell phones, tablet devices, computers or other apparatus, set-top boxes, handheld, kiosks, etc. Some portions of the detailed descriptions are presented in terms of algorithms and symbolic representations of operations on data bits within a computer memory. These algorithmic descriptions and representations are the means used by those skilled in the data processing arts to most effectively convey the substance of their work to others similarly skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments of the invention also relate to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The web servers may be any commercially available web server programs, such as the Apache Server for UNIX, IIS for Windows, or ligHTTPd.

Third party web services may include, but are not limited to Flickr, Facebook, Picasa, StumbleUpon, and general-purpose web servers and services.

In one exemplary embodiment, web browser clients may comprise the INTERNET EXPLORER™ client developed by Microsoft Corp. of Redmond, Wash., or the MOZILLA FIREFOX™ client developed by Mozilla Corporation of Mountain View, Calif.

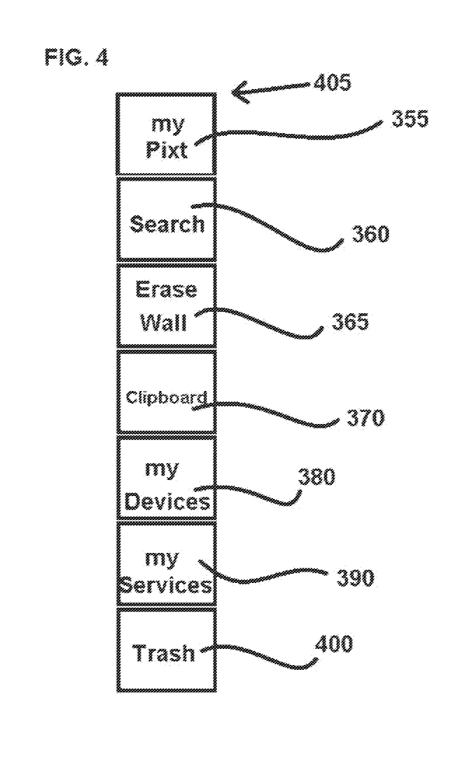

It should be understood that, according to one embodiment of the present invention, images, videos, or tiles can be moved across a background by the user. The images, videos, or tiles can move in a pre-ordained fashion (auto scroll), or can be moved in any direction and fashion the user desires. Clicking a cursor or mouse pointer stops the auto scroll, and reloading the webpage on which the present invention is deployed will begin the auto scroll. If a tile is clicked, the present invention has the ability open video player full screen—without the video player being a popup window. Image searches can be incorporated based on the name of the image, the size of the image, the date of the image, the content of the image, or any other variable of the image. Searches can be done on natural language and or boolean strings, as well as on combinations of tag words across multiple Content Management Systems (CMS). An example of the current search capabilities is shown in FIG. 4.

It is contemplated that images that are held or maintained on FLICKR™, could be automatically imported based upon FLICKR™ search capability using user name, key words(s), tag(s), group(s), set(s), and/or searching within sets. It is similarly envisioned that images stored on other similar photo hosting sites

The present invention can randomize the images shown, and upon a reloading of the webpage, it can then randomize and then reload for a new set of random results; either fully random or based on preset parameters defined by the user.

The present invention could also function as a wrapper or plugin—which would let the user automatically create the user's own wall using the user's images, images from content from any source, and as many walls as the user desires. The user could then invite friends via FACEBOOK™ or any other social network or via email, mms, sms, or text message to view the user's wall(s), and/or the user can make the user's wall(s) public. It is contemplated that the user's wall(s) could be setup as sub-domains.

It is contemplated that the tiles of the present invention can be given default places on the screen so that they can be used as a menu system where each set of tiles leads to a sub set of tiles until the user arrives at the desired product or service. A cookie that is loaded on a user's local machine allows a user to move each layer of tiles wherever the user desires. The present invention remembers that configuration so that the user has the user's own menu system, customized to lead the user to the products or services that the user likes the most. It is contemplated that the user could drag a tile to a previous page or to any page so that the tiles can be regrouped at will.

The present invention can also be used as a visual organizational tool. Employees, companies, systems, etc. can be shown on a video display. By dragging tile over tile, the tiles can be organized into sets—and if desired—lines can be drawn from tile to tile, set to set, etc. to represent relationships, chain of command, and/or direction.

The present invention can additionally be employed for social shopping. In other words, the user can share the user's likes, dislikes, and menu choices with the user's friends; similarly, the user can allow the user's friends to see what the user is viewing as a potential purchase listening to, reading online, etc. in real time contemporaneously. It is expected that an audio share system such as GOOGLE VOICE™, SKYPE™, etc. will eventually be joined with the present invention.

According to the present invention, the user can open up a picture or video, grab a link to that picture or video, and provide that link to a second user. The second user, upon receiving the link, can click on the link to cause the picture or video tile. The picture or video tile can appear larger than other tiles to direct attention to the tile to which media element the link had been connected to.

It is contemplated that the present invention could be used as an overlay on any content management system.

Furthermore, it is contemplated that as a user drags the background of the present invention, additional tiles appear. In other words, the size of the background frame can be much, much larger then the actual screen display size. The background can be a virtual desktop of sorts that can stretch on for many screens that can be accessed by dragging the current background up, down, left, right, etc., ad infinitum.

The present invention can be used as a mirror in a mirror type system so that a tile leads to another page of tiles, allowing different feeds from different contact management systems from different feeds. Essentially, the present invention can be an interface for all of a user's digital needs. It is similarly contemplated that the present invention could act as an instant website generator that is navigable. Once the tiles are created, then the background and tiles could be made publicly available for browsing on the Internet.

According to the present invention, the user can create a note/message/video/picture/entranceway to a 3d platform (Media) and send the note/message/video/picture/entranceway to itself or another user. Via a contact management system or feed, the note/message/video/picture/entranceway is placed on the tile wall. If the information created by the user is only text, then the text message can be displayed as the first few words of the information—or the text message can be displayed via pictures that the present invention auto picks to correspond to the information. Information can be placed into a queue so the information does not go live immediately until the user or another user grants approval for the note/message/video/picture/entranceway to go live on the Internet in a wall (tile page). In this manner, the buffer time provided to approve posted media content may exhibit an added security benefit of the present invention.

It should be understood that all walls of the present invention can be shown inside FACEBOOK™ as a tab or page inside FACEBOOK™. The tab can be added a user's own FACEBOOK™ page through a single click of a button.

Some alternative embodiments of the present invention are the following: The tiles, which are preferably shown in semi-2d, could also be shown in 3d with more then two sides. In such an embodiment, flipping a single tile results in a box view or a many sided view. Additionally, it is contemplated that a button click could also unfold the multi-sided view to allow viewing of all media in the tile. In this manner, sets could be “physically” joined for easier classification and organization. It should be understood that, preferably, the user decides which types of media the user wants to be accessible in any particular wall.

The present invention could also be extended to the after market industry, as the present invention allows display on any Internet-based system, including, iPad, flat screens, touch screens, mobile phones, cars, etc. In a car, food choices could be displayed per the present invention, and clicking on the food choice would drop the user to a map showing the location for the food type desired. The present invention could similarly act as an interface with other desired goods, such as gas, museums, parks, etc.

Moreover, the present invention should be understood to be a system and method for displaying and interacting with media content and associated data or interactions. It should be understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

Additionally the current invention allows the user to navigate through live feeds of content and media that automatically appear upon the tiles. There are many ways of navigating through the content that the technology provides. One way is to click on the background and rag which will move the current tiles off screen, allowing new ones to auto appear. A second way is through the use of an on screen joy stick-like navigation tool, and a third method allows the user to double click on the background in order to center that part of the screen.

The user may also sub-navigate into new content displayed within one of the tiles. By clicking on a tile and flipping it over, links displayed on the reverse side of the virtual tile allow for further navigation into other media streams. This navigation can show the media either within the back of the tile or can open a new browser window or tab. The invention is also able to display additional tiles in the back side of some single tiles, which, when expanded, displays an entirely different tile group.

Additionally, the present invention is preferably equipped with a toolbar (405) as seen in FIG. 4. It is envisioned that the toolbar (405) is to be located on the margin of the presentation and interaction model, and provides the user with an assortment of icons, each designed for a different purpose. In the preferred embodiment of the present invention, the toolbar (405) is maintained on the left margin. It is envisioned that the user may opt to hide the toolbar when he or she chooses, such as during a presentation to a group of individuals, providing more pannable space on the screen. The toolbar (405) includes an icon titled my pixt (355), which serves to provide the user with a convenient manner of managing a select set of settings. The toolbar (405) also includes an icon labeled search (360), which, when selected by a user, provides the user with a text field to input search criteria based on tags, titles, and other metadata relating to each media object. Searches are preferably conducted instantly.

Another icon exhibited in the toolbar (405) is the clipboard (365), which provides an easy place for a user to temporarily store media or text. This is specifically oriented to temporarily hold virtually ‘pasted’ media objects or text that has been copied from other virtual locations, similar to how conventional virtual clipboards operate within a conventional operating system. Another icon, labeled ‘erase wall’ (365) allows the user, when selected, to erase the entire wall of media, and begin with a blank wall. It is envisioned that, upon selection, the user will be prompted with a conventional message ensuring that the user's selection to erase the entire wall was intentional.

Another icon preferably located on the toolbar (405) is my devices (370). My devices (370), when selected by a user, preferably displays an additional set of icons beside the toolbar (405). Each icon within this set is affiliated with a specific device type. These device types include, but are not limited to, cameras, phones, USB storage devices, computer files, webcams, eSATA drives, and other computer peripherals. In practice, the user would first select my devices (370), and then select the icon corresponding to the device he or she wishes to upload media from, in order to be displayed within the interaction and display model of the present invention. It is the intent of my devices (370) to facilitate the rapid uploading of media content to the servers of the present invention by a user. Selecting the webcams option preferably allows the user to take an instant picture, and upload it to the server computer of the present invention.

My services (375) is an additional icon preferably found on the toolbar (405). My services (375) provides the user with an easy method of both sharing and importing photos from other services into the interaction and display model of the present invention. Upon selection of my services (375) by the user, the user is prompted with the option to select a popular service compatible with the present invention. It is envisioned that the list of compatible services available to the user will grow as more media services are created. The user then selects the service to import media content from, such as FACEBOOK™, TWITTER™, PICASA™, SNAPFISH™, PHOTOBUCKET™, and others. Similarly, media content displayed on the present invention may be shared via these services as well. After providing account credentials, photos may then be easily displayed and/or imported into the present invention.

Alternatively, account settings, wall creation, wall management, user permissions, and user login settings are preferably configured via a horizontal menu bar at the top of the interaction and display model of the present invention. Users may opt to make their wall publicly available for everyone to view, or simply a select few users to view. This is accomplished via the permissions settings page or a dropdown menu.

A URL shortener may be employed in conjunction with the presentation and interaction model of the present invention, which serves to facilitate sharing of specific URLs directed at an individual's wall display page. The URL of the individual's specific wall webpage is shortened via conventional means, in order to make sharing the link easier, especially within limited character space, such as the 140 characters allowed within a TWITTER™ post, conventionally known as a Tweet.

Alternate embodiments of the present invention provide for the capacity to create like sets within a series of media objects presented by the method of the present invention. This is preferably accomplished by stacking media objects atop one another in a pile on the desktop, also referred to as a wall. This feature is envisioned to be integrated into search results such that users can employ sets to enhance search algorithms when searching for similar items or media objects as those found within a user-defined set.

It is to be understood that the present invention is a presentation and interaction method for media, designed to provide an interface mimicking that of a physical, real-world media display. The present invention enables a user to interact with media objects in a virtual 3D environment as though they were physically on a table in front of the user. The intent of the present invention is to virtually recreate the effect of effectively dumping a box of Polaroid™ instant photos representing media objects on a desk, and enabling the user to fully interact with both the back and front of the photos as though they were physical objects. The media objects are equipped with a back, which is fully actualized as being interactively available for the user to view, add data to, or incorporate into his or her presentation. The present invention is equipped with the capacity to be linked to an assortment of photo hosting, media hosting, and social networking sites, and display media located on other external servers within the framework of the presentation and interaction model of the present invention. The present invention is preferably capable of sourcing, organizing, setting the permissions, publishing, and ultimately sharing a variety of media objects via a virtual, scrollable, seemingly infinite desktop on an internet connected device.

It should be understood that the preferred embodiment of the present invention accomplishes all that is described by using Java Script, so that the computer accomplishes the claimed method. It should be understood that a conventionally skilled programmer would understand and be able to reproduce the claimed method based on the above description.

The present invention is an online media presentation method that consists of uploading a first set of media to a computer. The computer, then displays and treats the set of media as though it were a simulated first photo. Metadata pertaining to the photo or other media form is displayed on a reverse side of the simulated first photo. The computer simulates a background that appears behind the media objects, including photos, which appears to be infinitely scrollable. Additionally, the computer treats the simulated first photo as though the simulated first photo were lying on the background, such as a desktop. In this method, it is envisioned that the first set of media is an actual picture. A user, interacting with the computer via an interface device, is able to flip the first photo to a backside of the first photo. This virtual backside of photos within a 3D virtual environment may be written on or edited by a user. Similarly, the computer displays and treats a second set of media as a simulated second photo. Users may flip the simulated first photo to a backside of the simulated first photo, while displaying a front side of the simulated second photo. In other words, more then one photo may be displayed aside each other or stacked on top of each other in multiple orientations. Media objects represented by virtual photos are independently rotated and flipped, in accordance to how physical photographs behave in the physical world. Similarly, the present invention provides for the stacking of the simulated first photo and the simulated second photo so that the simulated first photo and the simulated second photo are not joined together in one file. Despite being stacked atop one another, these media objects remain distinct files unless otherwise requested by the user to create a ‘set.’

We claim:

1. An online media presentation method comprising:
uploading a first set of media to a computer;
the computer displaying and treating the first set of media as a simulated first photo;
making available metadata of the first set of media on a reverse side of the simulated first photo;
the computer displaying a background that appears to be infinitely scrollable; and
the computer treating the simulated first photo as if the simulated first photo were lying on the background.

2. The method of claim 1, wherein the first set of media is an actual picture.

3. The method of claim 1, further comprising:
flipping the simulated first photo to a backside of the simulated first photo.

4. The method of claim 3, further comprising writing on the backside of the simulated first photo.

5. The method of claim 2, further comprising rotating the simulated first photo any number of degrees.

6. The method of claim 1, further comprising the computer displaying and treating a second set of media as a simulated second photo; and further comprising flipping the simulated first photo to a backside of the simulated first photo, while displaying a front side of the simulated second photo.

7. The method of claim 6, further comprising stacking the simulated first photo and the simulated second photo so that the simulated first photo and the simulated second photo are not joined together as one file.

8. The method of claim 1, further comprising:
wherein the first set of media is an actual picture;
further comprising flipping the simulated first photo to a backside of the simulated first photo;
further comprising writing on the backside of the simulated first photo;
further comprising rotating the simulated first photo any number of degrees;
further comprising the computer displaying and treating a second set of media as a simulated second photo;
further comprising flipping the simulated first photo to a backside of the simulated first photo, while displaying a front side of the simulated second photo; and
further comprising stacking the simulated first photo and the simulated second photo so that the simulated first photo and the simulated second photo are not joined together as one file.
